(19) United States
(12) Patent Application Publication
(10) Pub. No.: US 2020/0131008 A1
(43) Pub. Date: Apr. 30, 2020

(54) Device for removing, storing and installing convertible SUV hard tops and removable doors

(71) Applicant: Frederick Hall, Spring Hill, FL (US)

(72) Inventor: Frederick Hall, Spring Hill, FL (US)

(21) Appl. No.: 16/172,736

(22) Filed: Oct. 27, 2018

(51) Int. Cl. B66C 23/48; F16M 11/10; F16M 11/42

(52) U.S. Cl. CPC B66C 23/48; B60J 7/106; F16M 11/42; F16M 11/10

(57) ABSTRACT

A device designed for the removal, storage, and installation of removable hardtops or doors from convertible sport utility vehicles, comprising a wheeled base unit, a vertical support structure and a platform assembly, wherein the base unit is aligned directly below the platform unit and the vertical support structure connects them together, wherein the device can be disassembled for simple shipping, is adjustable for height and depth to accommodate different SUV models, and includes markers for easy assembly.

### CROSS REFERENCE TO RELATED APPLICATIONS

Not applicable.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

### Field of the Invention

The invention is a device for the removal, storage and installation of convertible sport utility vehicle (SUV) hard tops and removable doors.

### Background of the Invention

Convertible two door and four door SUVs are typically sold with collapsible soft tops standard on these vehicles. For many individuals, these convertible soft tops do not provide adequate weather or noise insulation. Additionally, it can be a difficult task to collapse and erect the soft tops on the vehicle, particularly on the 4-door vehicles.

Various types of removable hard tops have been made available and configured to replace the standard collapsible soft tops for the different convertible SUVs. These convertible hard tops provide significantly better weather and noise insulation than their soft top counterparts. However, in order to enjoy the convertible feature of an SUV it is often desirable to remove the hard top.

A SUV removable hard top is typically configured to be easily attachable and detachable to the SUV. Typical SUV removable hard tops are relatively heavy, bulky, and awkward to handle. The size and weight present a significant problem for removal and installation, especially by one person working alone. Typically, a group of at least two people is required to remove or install SUV removable hard tops. In order to further share the weight load, a group of four people is preferable to lift and remove or install a removable hardtop, with each person handling or lifting each corner of the hardtop in concert with others in the group.

In order to simplify the process of installing and removing hardtops from the convertible SUVs, many owners will utilize specialized overhead lifts that are installed in their garages to perform this function. When utilizing these overhead lifts, owners will position their vehicle below the stationary lifts, and then connect the hardtop to the overhead lift, release the hardtop from the SUV, lift the hardtop above the SUV, and then drive the vehicle from underneath the lift and detached hardtop. Similarly, when installing the hardtop the vehicle will be positioned under the lift and hardtop, which will be then lowered onto the SUV.

While these lifts are an effective method of removing and installing convertible hardtops on an SUV, they can provide logistical issues. First and foremost, utilization of a hoist-style lift as described above requires the owner of the vehicle to have a garage or other support structure available onto which the hoist system can be installed. Not all owners of these types of vehicles have these facilities available to them. Additionally, these types of lifts are fixed and not portable. Therefore, they may not be suitable for owners of these types of vehicles who may rent or who want to have the ability to remove the top from their vehicle at locations other than their home, such as when they are on vacation or a camping trip. The fixed nature of such systems can also result in difficulties reinstalling the hard top after removal, as the vehicle must be precisely positioned for proper reinstallation. Finally, most of these fixed position lift devices do not allow for parking vehicle in the garage while hard top is affixed to the device.

A freestanding device capable of installing and removing a hardtop from a convertible SUV as well as compactly storing such hardtop while disengaged from the vehicle is known from U.S. Pat. No. 9,643,823 to Applicant, Federick Hall. The Hall patent teaches a movable device allowing a single user to remove, store and reinstall a SUV hardtop, with a vertical lifting means for raising and lowering such hardtop while disengaged from the SUV.

The invention of the Hall patent, however, does not include a number of features useful for (i) protecting the integrity of the hard top upon removal, (ii) promoting ease of shipping and assembly of the invention, (iii) providing stability of the invention when in use and (iv) promoting mobility of the invention when in use, especially on uneven ground and (v) removing and storing removable doors from SUVs with such features.

### BRIEF SUMMARY OF THE INVENTION

In a preferred embodiment, an apparatus for removing, storing, and installing removable hardtop devices from vehicles comprising:
a movable base unit which is sufficiently long and wide to support the apparatus from longitudinal and axial moments with and without the hardtop engaged;
a vertical support structure having a lower and upper end, wherein said lower end is affixed to said movable base and said upper end is attached to a means for vertical lifting:
a means for vertical lifting which is connected to said vertical support structure and allows the apparatus to exert force vertically for removing the hard top from the vehicle, sustaining the hardtop at a fixed height once the hardtop has been removed from the vehicle, and allowing the hardtop to be controllably lowered onto the vehicle during installation;
a top platform assembly attached to said vertical lifting means, which top platform assembly slopes upward away from the device at an angle of 1 degree to five degrees and interfaces with the hardtop to distribute lifting forces evenly throughout the hardtop and is capable of securing and supporting the hard top longitudinally and axially while the hardtop is installed on the apparatus; and
wherein the apparatus may be positioned to the hardtop while is installed on the automobile and selectively raised or lowered by said vertical lifting means.

In another preferred embodiment, the apparatus as described herein, further comprising wherein molded pads are affixed to the upper surface of the top platform to cushion and protect the vehicle hard top upon engagement and removal by the device.

In another preferred embodiment, the apparatus as described herein, further comprising wherein the device is comprised of slidably assembled tubular components, and alignment markers embodied as colored dimples are located on individual tubular components evidencing the location for alignment of other components upon assembly.

In another preferred embodiment, the apparatus as described herein, wherein a plurality of casters from 3″ to 6″ in diameter are attached to the underside of the movable base.

In another preferred embodiment, the apparatus as described herein, wherein the casters are each 4″ in diameter.

In another preferred embodiment, the apparatus as described herein, wherein the top platform comprises detachable support rail and separately detachable support rail extenders to extend the horizontal area available for removal of larger hardtops.

In another preferred embodiment, the apparatus as described herein, wherein the support rails and support rail extenders are each tubular designs with a squared exterior configuration.

In another preferred embodiment, the apparatus as described herein, further comprising wherein the means for vertical lifting which is connected to the vertical support structure comprises a cable running through an adjustable yoke with two manually adjustable screws that can be tightened to secure said cable.

In another preferred embodiment, the apparatus as described herein, wherein the angle of slope of the top platform assembly is approximately three degrees.

In another preferred embodiment, the apparatus as described herein, configured for removal of vehicle doors, wherein each detachable support rail extender extends vertically downward towards the movable base from a midpoint of the corresponding support rail; each support rail terminates in a top edge grip for engaging the vehicle door along a top edge of a window opening; each support rail extender terminates in a front edge grip for engaging the vehicle door along its lower edge.

In another preferred embodiment, a method of removing a removable hardtop from a vehicle using the apparatus of claim 1, such apparatus comprising a movable base structure, a vertical support structure, a means of vertical lifting and a top platform assembly, such method comprising the steps of: positioning the movable base unit to the back of the vehicle; positioning the vertical support structure having a lower end and upper end, wherein said lower end is affixed to said movable base and said upper end is attached to a means for vertical lifting; engaging the top platform with the hardtop to effect lifting, wherein the top platform assembly is attached to the vertical lifting means and such top platform assembly slopes upward away from the apparatus at an angle of 1 degree to five degrees and interfaces with the hardtop to distribute lifting forces evenly throughout the hardtop and is capable of securing and supporting the hard top longitudinally and axially while the hardtop is installed on the apparatus; and moving the means for vertical lifting, which is connected to said vertical support structure, thereby exerting vertical force to remove the hardtop from the vehicle, sustain the hardtop at a fixed height, and thereafter allow the hardtop to be controllably lowered onto the vehicle during reinstallation.

In another preferred embodiment, a method of removing a removable door from a vehicle using the apparatus of claim 10, such apparatus comprising a movable base structure, a vertical support structure, a means of vertical lifting and a top platform assembly, such method comprising the steps of: positioning the movable base unit to the side of the vehicle with the door to be removed and facing the rear of the vehicle; positioning the vertical support structure having a lower end and upper end, wherein said lower end is affixed to said movable base and said upper end is attached to a means for vertical lifting; engaging the two rail extenders with the vehicle door to effect lifting, wherein the two top edge grips engage the vehicle door along a top edge of a window opening and the two front edge grips engage the vehicle door along its lower edge; and moving the means for vertical lifting, which is connected to said vertical support structure, thereby exerting vertical force to remove the door from the vehicle, sustain the door at a fixed height, and thereafter allow the door to be controllably lowered onto the vehicle during reinstallation.

### BRIEF DESCRIPTION OF THE DRAWINGS

FIG. 1 is a side elevation view illustrating the sport utility vehicle hard top removal device of the current invention.

FIG. 2 is an enlarged perspective view illustrating the platform assembly.

FIG. 3 is an enlarged perspective view illustrating the pawl and gear assembly section of the tilting platform assembly.

FIG. 4 is an enlarged rare view illustrating the platform assembly and levers of the tilting platform assembly.

FIG. 5 is an enlarged top rear view illustrating the platform assembly levers of the tilting platform assembly.

FIG. 6 is an enlarged view illustrating the platform release mechanism of the tilting platform assembly.

FIG. 7 is a perspective view illustrating the underside of the platform and showing the pivot bracket of the tilting platform assembly.

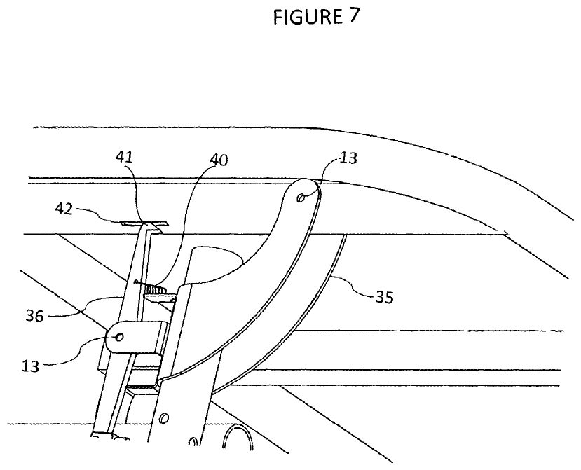

FIG. 8 is a perspective view illustrating the base and the castors.

FIG. 9 illustrates a left side view illustrating rotation of the platform assembly when the tilting mechanism is operated.

FIG. 10 is a left side view illustrating the hardtop in elevated position upon platform assembly for the hardtop storage apparatus.

FIG. 11 is a left side view illustrating rotation of the platform assembly for the hardtop storage apparatus.

FIG. 12 is a perspective view illustrating the hardtop storage apparatus according to this invention positioned in drivers side rear quarter positioned to the outside of the vehicle illustrating view to hardtop location position.

FIG. 13 illustrates the positioning to the interior of the vehicle positioned between rear wheels supporting the hardtop for removal.

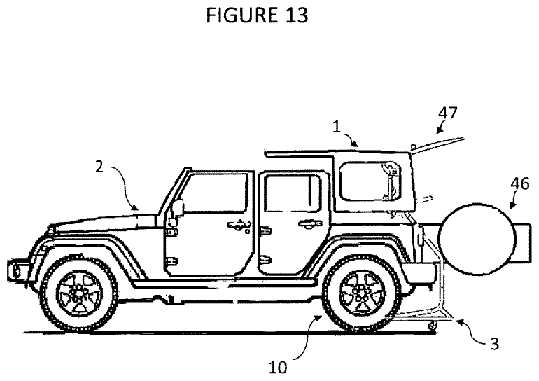

FIG. 14 is a view illustrating the positioning for the grip rail fingers for supporting the hardtop for removal.

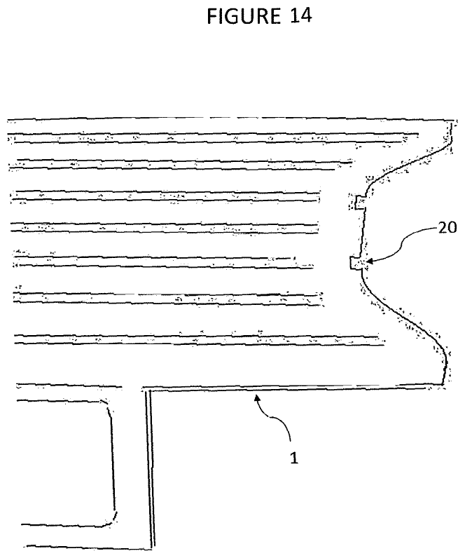

FIG. 15 is a left side view illustrating an alternate embodiment of the invention where the ratcheting lift assembly is replaced by an electric gear motor.

FIG. 16 is a close up view of alignment features common to each main component of the hardtop removal apparatus.

FIG. 17 is a close up view of the yoke and pawl features of the hardtop removal apparatus.

FIG. 18 is an exploded view of an alternate embodiment of the wheeled base unit of the hardtop removal apparatus.

FIG. 19 is a side view of the hardtop removal apparatus with rail extenders allowing for door removal.

### DETAILED DESCRIPTION OF THE INVENTION

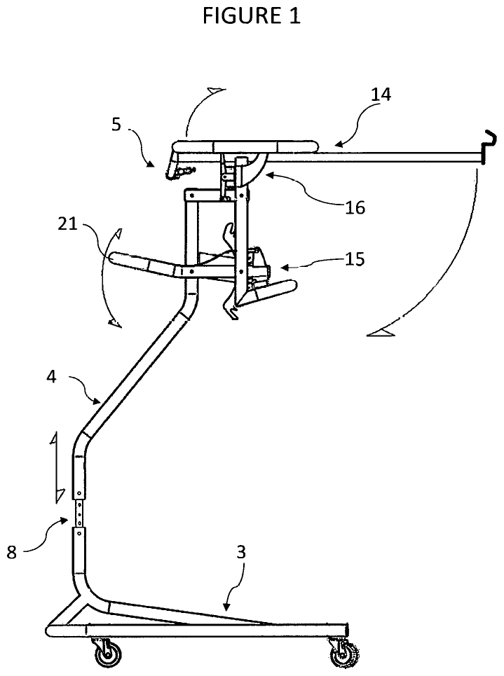

As shown in the drawings, the present invention provides a device designed for the removal, storage, and installation of removable hardtops 1 and doors 1A from convertible sport utility vehicles 2. As depicted in FIG. 1, in general the device comprises a wheeled base unit 3, a vertical support structure 4 and a platform assembly 5. The core components of the device are arranged such that the base unit 3 is aligned directly below the platform unit 5 and the vertical support structure 4 is connected to the rear of the base unit 3 and platform assembly 5 connecting the two together. The resulting structure is a “C” shaped unit, which is designed such that the weight and moment created when the hardtop unit 1 is loaded onto the platform assembly 5 its weight is counteracted and supported by the legs 6 of the base unit 3, preventing the device from toppling over.

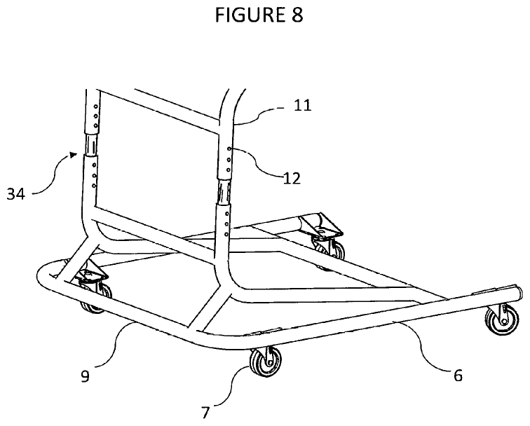

Referring to FIG. 8, In the preferred embodiment the base unit 3 is comprised of a “U” shaped frame 9 with two legs 6 with four casters 3 affixed to the legs 6. The frame 9 of the base unit 3 connects to the vertical support 4 structure near the rear of the base frame 9. In the preferred embodiment the frame and the vertical support structure are tube in tube slide-over connections 8 with a plurality of aligning holes 12, through which pins can be inserted (not pictured) to allow for simple height adjustment, however, these two units could be affixed to each other in any manner known to those skilled in the art, such as brackets and welding.

The most critical design aspect of the base unit is that the horizontal distance between the end of the base legs 6 and the vertical support 4 be sufficient to prevent the unit from toppling over when the hardtop 1 is installed on the platform assembly 5. The ends of the base legs 6 should extend from the vertical support 4 to at least the horizontal location of center of mass of the unit, both with the hardtop installed and the hardtop removed and ideally a bit past the center of mass for added stability.

Additionally, the lateral distance between the two legs 6 needs to be sufficient to provide lateral support and prevent the unit from tipping over sideways, however, the distance cannot exceed the distance between the inner side of the tires of the SUV 10. Exceeding the distance between the inner sides of the tires 10 would prevent the legs 6 of the unit from being able to roll underneath SUV 2 so that the platform assembly Scan align with the removable hardtop 1.

Referring to FIG. 8, attached to the underside of the legs 6 are four wheel and caster assemblies 7. These wheel and caster assemblies 7 allow the device to be aligned with the hard top 1 and roll away from the hardtop 1 once it has been detached from the SUV 2. In the preferred embodiment of the invention, the casters 7 are all free rotating, however, the casters 7 could be all fixed, a combination of fixed and free rotating casters 7, or any other arrangement known to those skilled in the art.

Referring to FIGS. 1 and 8, connecting the base unit 3 and the platform assembly 5 is a vertical support structure 4. The vertical support structure 4 comprises a single, or a plurality of vertical beams 11. In the preferred embodiment of the invention the vertical support structure 4 is variable in length to allow the device to be utilized with a variety of types of vehicles. In the preferred embodiment the variable height support beams 11 are hollow tube in tube structure 8 with a plurality of pin holes 12 and pins to allow for height adjustment. However, the inventor recognizes that height adjustment can be achieved through a number of methods known to those skilled in the art, such as, but not limited to, hydraulic or pneumatic cylinder and tube in tube structures with spring loaded push button retention pins.

Referring to FIGS. 1 & 2, attached to the top of the vertical support structure 4 is a platform assembly 5. The platform assembly 5 is affixed to the vertical support structure 4 via hinged (or pivoting) connections 13. In the preferred embodiment of the invention there are two vertical support beams 11 with four hinged/pivoting connections 13, two per support beams 11. While not critical to the operation of the invention, having two support beams 11 instead of a single support beam 11 helps prevent bending and binding at the hinged/pivoting connections 13 as a result of unstable or unbalanced loads.

The hinged/pivoting connections 13 used throughout the device in the preferred embodiment are achieved through pins or bolts running through holes that are drilled in the tube frame of the vertical support structure 4 and the platform assembly 5. However, the inventor recognizes that hinged/pivoting connections 13 can be achieved through a number of methods known to those skilled in the art, such as, but not limited to, template hinges and pivot hinges.

Referring to FIG. 1, The platform assembly 5 is comprised of three primary components; hardtop interface platform 14, a ratcheting lift assembly 15, which provides a means for vertical lifting, and a tilting assembly 16. The hardtop interface platform 14 allows the device to attach to and support the removable hardtop 1, and an approximately one to five degree upward slope a in the interface platform 14, away from the device body and towards the front edge grips 19, when the platform is fully extended, provides a cushion to offset the weight of the hardtop 1 once it is loaded onto the platform. In a more preferred embodiment, such upward slope a is approximately three degrees.

A plurality of molded pads 45 are located on the upward-facing surfaces of hardtop interface platform 14 to provide a cushion barrier between the metal platform and the inner surface of the hardtop 1, to prevent damaging or marring to the surface of the hardtop.

The ratcheting assembly 15 allows the operator to easily lift and lower the hardtop 1 or door 1A. The tilting assembly 16 allows the operator to tilt the hardtop 1 or door 1A when it is installed on the device, to reduce the footprint required for storage. In the tilted position, the hardtop will be engaged and held in place by the front edge grips 19.

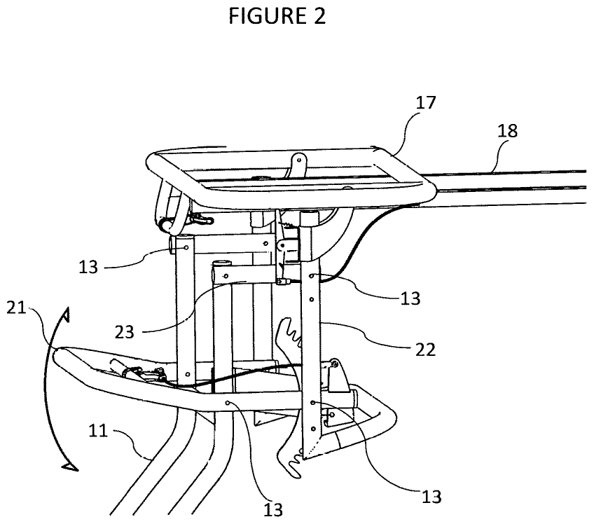

Referring to FIGS. 2 & 5, the hardtop interface platform 14 is comprised of a SUV top platform 17, a single or plurality of removable support rails 18, and a corresponding number of support rail tube sleeves (not pictured). The in the preferred embodiment the SUV top platform 17 is a rectangular shaped structure that will interface with the hardtop during the installation and removal of the hardtop unit. The SUV top platform 17 should be of sufficient length and width that the hardtop 1 can be rested on the platform 17 as it is removed from or lowered onto the vehicle 2 without instability. While in the preferred embodiment the SUV top platform 17 is rectangular shaped, the platform 17 could be designed with any shape such as an oval or triangle, as long as it is of sufficient length and width that the hardtop 1 can be rested on the platform 17 as it is removed from or lowered onto the SUV 2 without instability.

In the preferred embodiment of the invention, attached to the top surface of the top platform 17 and each support rail 18, are a plurality of molded pads 45. In a preferred embodiment, such molded pads 45 are comprised of natural or synthetic rubber and are adhered to the surface of the platform with a known commercial adhesive. Potential adhesives can be taken from the group comprising epoxies, urethanes, polyurethanes, polyimides, polyester resin, neoprene, elastomers, thermoplastics, thermosets, cyanoacrylate, acrylic polymers, or any other known commercial adhesive. In the preferred embodiment of the invention, attached to the SUV top platform 17, are two support rail sleeves (not pictured), which is the optimal number the inventor believes that using two support rails 18 maximizes stability while achieving cost efficiency. More or less than two support rails 18 and associated support rail sleeves could be utilized. These sleeves are hollow and the inner cross sectional segments of the sleeve provides a slightly larger representative profile of the cross-section of the outer surface of the support rail 18 which is inserted into it. On one side of each of the support rail tube a plurality of holes are drilled which will accommodate a push button or plunger locking mechanism (not pictured) which is located on each of the corresponding support rails. The length of the support rail tube sleeves must be long enough that the support rails 18 are sufficiently supported as to ensure the support rails 18 maintain alignment. While in the preferred embodiment of the invention there are two longer support rail sleeves, the function of the support rail sleeves could be sufficiently achieved using tour sleeves shorter in length, but sufficiently spaced apart to ensure the support rails maintain alignment.

Referring to FIG. 2, inserted into the two support rail tube sleeves are two support rails 18. The support rails 18 each are comprised of long tube members where the outer cross-sectional segments of the support rail 18 provides a smaller larger representative profile of the cross-section of the inner surface of the support rail sleeve which it is inserted into. Internally, each support rail has a push button clip locking mechanism which secures the support rails in their intended location when the mechanism aligns with the corresponding holes drilled in the support rail sleeves.

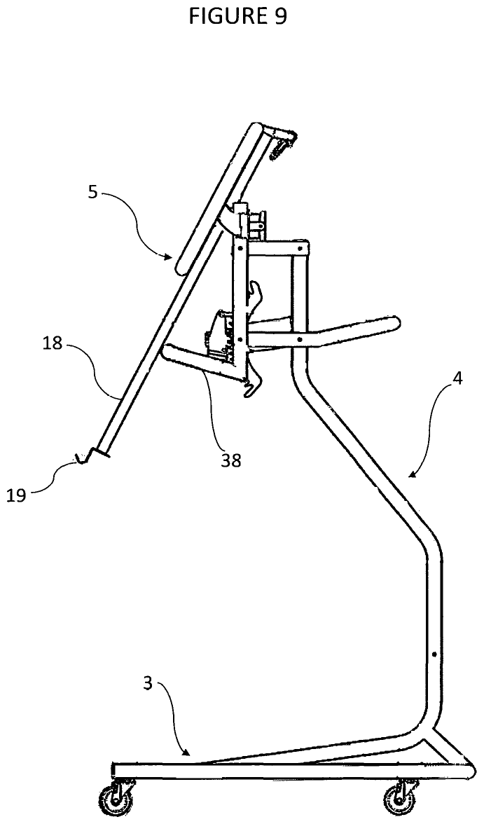

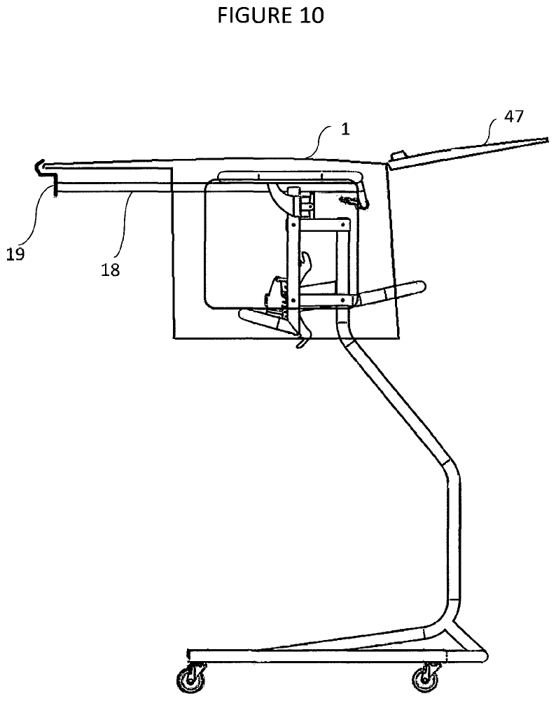

Referring to FIGS. 9, 10 & 11, at the end of each support rail is a front edge grip 19. The front edge grips 19 are sized accordingly and in a manner where that grips 19 fit into the groove or notch 20 existing in the hardtop 1, retaining the hardtop 1 firmly in place with respect to the removal device, while the wheeled install/removal device can moved about. In the preferred embodiment, each grip 19 has an optional protective coating or cover which prevents the grips from scratching the hardtop.

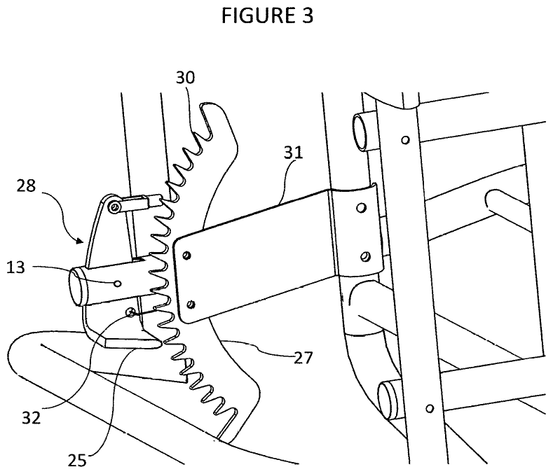

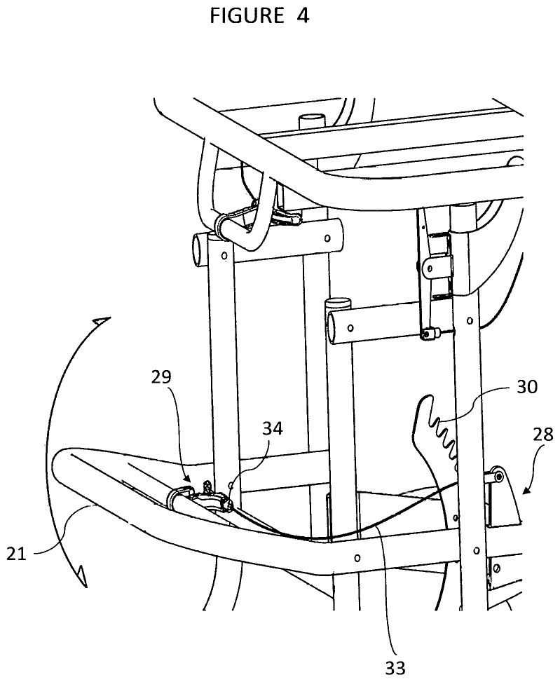

Referring to FIGS. 3, 4, & 5 the ratcheting lift assembly 15 is primarily comprised of the following components; a lift lever 21, vertical platform push rods 22, horizontal lift support members 23, a ratcheting mechanism 24, and a release mechanism 29.

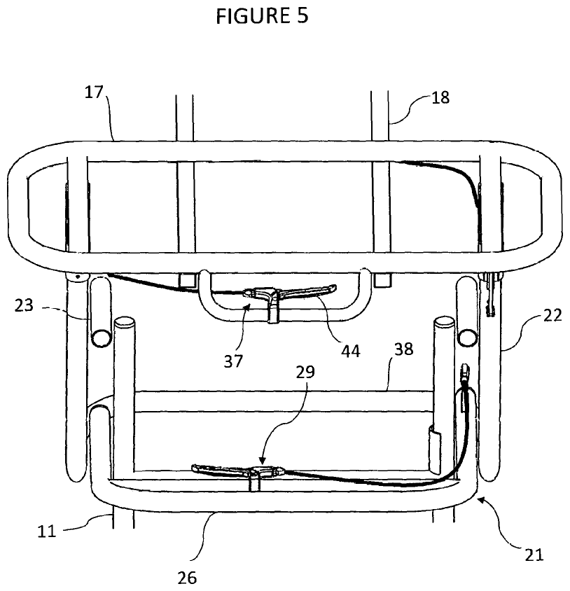

Referring to FIG. 5, in the preferred embodiment the lift lever 21 is a U-shaped hollow frame tube that is connected to the vertical support beams 11 in two parallel locations via pinned hinged connections 13 and is also connected to the two vertical platform push rods 22 via parallel pinned hinged connections 13 as well. The U-shaped bar 21 is oriented such that the straight section 26 of the U is oriented towards the operator while the lift is in use. The straight section 26 provides the operator with a handle which he can exert a downward force which will push the vertical platform push rods 22 upward, lifting the hardtop 1 from the vehicle. The further the distance between the handle 26 and the hinged connections 13 to the vertical support beams 11 the more leverage the operator will have to lift the hardtop 1 from the vehicle 2, requiring the operator to exert less energy to remove the top 1.

Referring to FIG. 2, the vertical platform push rods 22 are hollow frame tubes that are connected to the lift lever 21 via pinned hinged connections 13, connected to the to the horizontal lift support beams 11 via pinned hinge connections 13, and is fixedly attached to the tilting assembly 16. The hollow frame tubes have a plurality of holes drilled in them (not pictured) to allow for height adjustment via changing the locations of the pinned hinge connections. The vertical platform push rods 22 function to transfer the force generated by the operator when he/she pushes downward on the handle to the platform assembly 5 and hardtop 1 and move upward to detach the hardtop 1 from the vehicle 2. Having the vertical push rods 22 attached to the vertical support beams 11 in two locations, via the lever 21 and the horizontal lift support members 23, ensures that the vertical push rods 22 maintain a perpendicular orientation to the ground while moving up and down.

Referring to FIG. 2, the horizontal lift support members 23 are hollow frame tubes that are connected to the vertical support beams 11 via pinned hinged connections 13 and to the vertical platform push rods 22 via pinned hinge connections 13. The horizontal lift support members 23 function to provide a second attachment point for the vertical platform push rods 22 to the vertical support beams 11 which ensures that the vertical push rods 22 maintain a perpendicular orientation to the ground while moving up and down, thus preventing the hard top from tilting during removal or storage and instead keeping it parallel to the vehicle top.

Referring to FIG. 3, the ratcheting mechanism 24 is primarily comprised of; a lift gear 27, a pawl 28, and a release mechanism 29. The lift gear 27 is a semi-circular shaped gear with a plurality of teeth 30. The radius of the lift gear 27 should be the same or similar radius as the arc the device makes when it is raised and lowered to ensure the pawl 28 and lift gear 27 remain engaged. The lift gear 27 is fixedly attached to the one of the vertical support beam 11 and protrudes from away from the operator via a bracket 31.

The pawl 28 is a spring loaded finger that is attached to the lift lever 21 via a hinged connection 13 and has a spring 32 that connects and compresses the pawl 28 and the gear 27 together. The spring 32 is attached to the lower half of the pawl 28, below the hinged connection 13. The finger device on the pawl 28 is downward sloping and contoured to fit the teeth 30 of the gear 27. When the operator pushes down on the handle the vertical platform push rods 22 move in the unrestricted (i.e., upward) direction, and the pawl 28 easily slides up and over the similarly sloped edges of the teeth 30, with a spring 32 forcing it (often with an audible ‘click’) into the depression between the teeth 30 as it passes the tip of each tooth. When the operator stops pressing downward on the handle 21 the weight of the hardtop 1 attempts to move the vertical platform push rods 22 in the opposite (downward) direction, however, the pawl 28 will bind against the oppositely sloped edge first tooth it encounters, thereby locking it against the tooth and preventing any further motion in that direction.

Referring to FIG. 4, the release mechanism 29 comprises a cable 33 that is attached to the top part of the pawl 28 above the hinged connection 13. The other part of the cable 33 is attached to a tensioning mechanism 34 located on the lift lever. When the tensioning mechanism 34 is engaged by the operator, the cable 33 tightens, and disengages the pawl 28 from the gear teeth 30. Once the pawl 28 has been disengaged the vertical platform push rods 22 can move freely in the downward direction. In the preferred embodiment of the invention the release mechanism 29 is achieved using a bicycle style brake lever, however, this could be achieved through any method known to those skilled in the art.

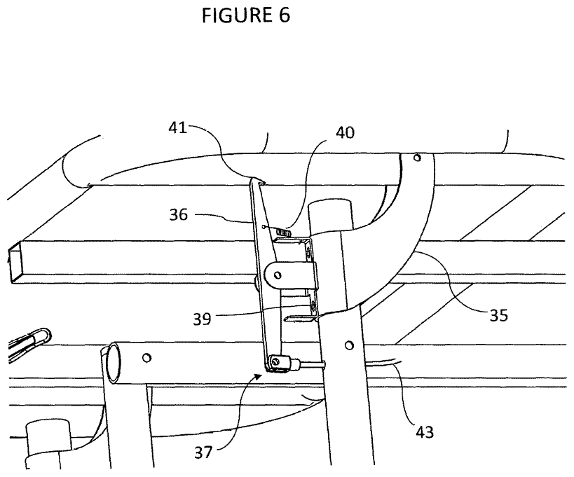

Referring to FIGS. 5, 6, & 7, the tilting assembly 16 is primarily comprised of the following components; pivot brackets 35, a platform lock 36, a release mechanism 37, and a rest rail 38. The tilting assembly 16 allows that platform 5 and hardtop ito rotate downward so that the footprint of the detached hardtop 1 when installed on the removal device is reduced, making it easier to move and store.

The pivot brackets 35 are a pair of semi-circular brackets. One end of each of the brackets 39 is fixedly attached to the one of the vertical platform push rods 22 and the other end is attached to the SUV top platform 17 via pinned hinge connections 13.

The platform lock 36 is a spring loaded lever that is fixedly attached to one of the pivot brackets 39 and has a spring 40 that connects and compresses the top end of the lever and the pivot bracket 35 together. The spring 40 is attached to the upper half of the lever, above the hinged connection 13. The upper tip of the lever has a hook shape 41 that inserts into a hole 42 in the SUV top platform. Once the hook shaped tip 41 is inserted into the hole in the platform hole 42, the spring 40 engages the hook 41 inside of the hollow tubing, preventing the platform 17 from rotating around the hinged connections 13 with the pivot brackets 35.

The release mechanism 37 comprises a cable 43 that is attached to the bottom part of the pawl 28 below the hinged connection 13. The other part of the cable 43 is attached to a tensioning mechanism 44 located on the SUV top platform 17. When the tensioning mechanism 44 is engaged by the operator, the cable 43 tightens and disengages the hook 41 from the hole of SUV top platform 42. Once the hook 41 has been disengaged the SUV top platform 17 can rotate around the pivot brackets 35. In the preferred embodiment of the invention the release mechanism 37 is achieved using a bicycle style brake lever, however, this could be achieved through any method known to those skilled in the art.

The rest rail 38 is a mechanical stop that prevents the platform assembly 5 and hardtop 1 from hitting the ground when it is tilted. Due to the length of an SUV hardtop 1, the device can only be tilted to a particular angle until the hardtop 1 will hit the ground potentially damaging the top 1. Depending on the make of the vehicle this angle will vary. In the preferred embodiment of the invention, the rest rail 38 is a hollow “C” shaped piece of tube that connects to bottom of each of the vertical platform push rods 22 and protrudes away from the vertical support members 23.

It should be noted that the inclusion of the tilting assembly 16 in the device is optional, and device can still perform the basic function of installing and removing a hardtop 1 without the tilting assembly 16 installed on the device. By eliminating the components of the tilting mechanism 16 and fixedly attaching the vertical push rods 22 to the SUV top platform 17 perpendicularly, the tilting assembly 17 can be simply removed from the device.

In the preferred embodiment of the device, the device is constructed of powder coated carbon steel, due to its strength, malleability, rust prevention, and cost. However, the inventor recognizes that the device could be constructed of any number of materials that can be formed onto the required structures and still be rigid and strong enough to support the hardtop, such as carbon fiber, plastics, PVC, and fiberglass.

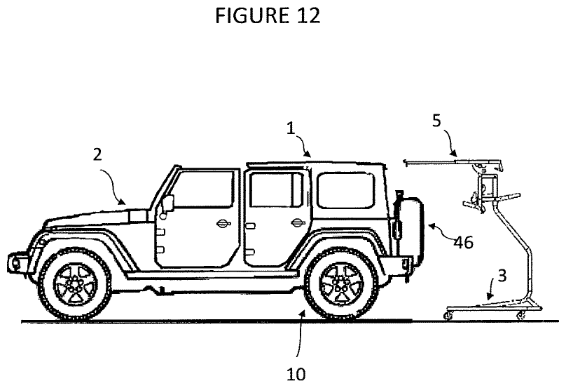

Referring to FIGS. 12 & 13, when removing the hardtop 1 from a SUV 2 using this device, and operator will begin by releasing any latches affixing the hardtop 1 to the vehicle 2 and opening the rear gate 46 and glass of the hardtop 47. The operator will the lower the platform assembly 5 below the clearance level of the glass 47 for the hardtop using the release mechanism 29 for the ratcheting assembly 15. The operator will then roll the device into place, with the legs of the base 3 between the rear tires of the SUV 2, and the device in line with the SUV 2.

Once the device is in place, the operator will exert a downward force on the lift lever 21, which will raise the platform assembly 5 until it engages with the hardtop 1. The operator will continue to exert a downward force on the lift lever 21, de-coupling the hardtop 1 and the SUV 2, and will continue to exert this force until the hardtop 1 is clear of the vehicle 2. Once the operator ceases to exert the downward force, the ratcheting assembly 15 will maintain the elevated position of the hardtop.

Referring to FIGS. 10 & 14, once the hardtop 1 is clear of the vehicle 2, the operator will now install the support rails 18 from the front of the hardtop 1 into the rail sleeves and engaging the push button clip locking mechanism so that the front edge grips 19 engage with the notches in the hard top 20. This will secure the hardtop 1 by means of the front edge grips 19. The operator can now roll the entire apparatus with hardtop 1 securely mounted away from the vehicle 2 so the legs of the base unit 3 clear the wheels and are to move about. The operator can now lower the platform assembly 5 with hardtop 1 in place from a horizontal elevated position by disengaging the ratcheting mechanism 24 using the release mechanism 29, whereby lowering the top to the desired height.

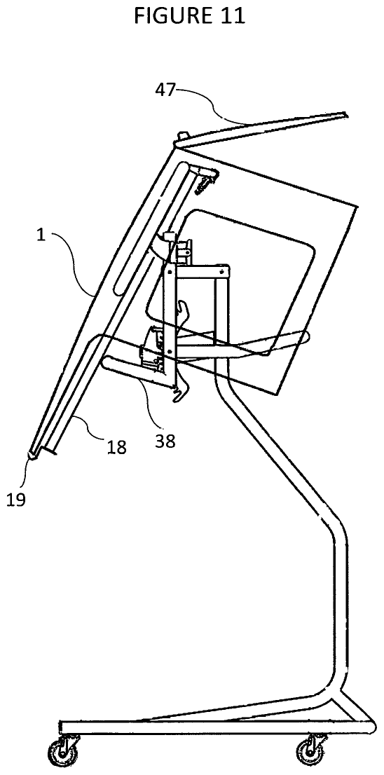

Referring to FIG. 11, once the operator has lowered the hardtop 1 from an elevated position, the device can be tilted for ease of storage. The operator can engage the tilt assembly 16 by engaging the release mechanism 37 for the tilt assembly 16. Once the release mechanism 37 has been engaged the platform assembly 5 and hardtop 1 will rotate around the pivot brackets 35 to the rest position against the rail rest 38 for easy storage. The operator can now roll or maneuver the entire apparatus with hardtop 1 securely mounted in place by means of casters 7 mounted to the base 3 to anywhere you are able to do so with ease or minimal effort. In a preferred embodiment, the casters have a sizeable diameter of approximately 3″ to 6″, with a preferred diameter of 4″, thus allowing the device a high level of stability, whether encumbered by a hardtop 1 or door 1A or neither, and whether the ground traversed is level or uneven.

According to the design of FIG. 11, the hard top may be stored in an upright position over the vehicle hood while the device legs contact the vehicle front bumper, providing maximum storage capacity with minimal space requirements.

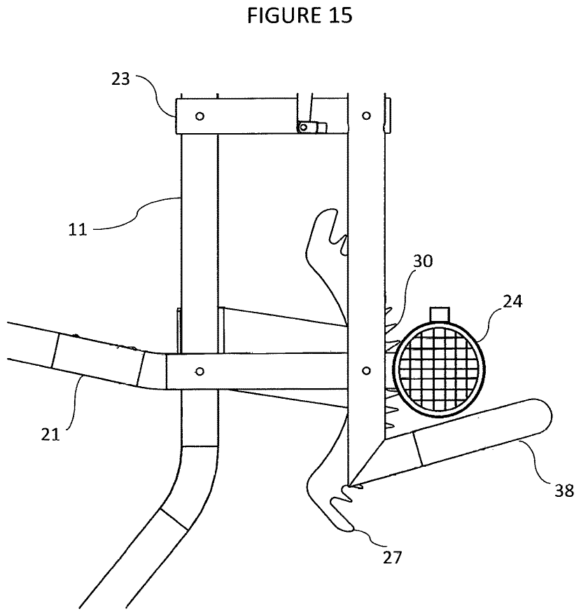

Referring to FIG. 15, in an alternate embodiment of the invention, the ratcheting lift assembly is replaced by an electric gear motor. This alternate embodiment is primarily comprised of the following components; a lift lever 21, vertical platform push rods 22, horizontal lift support members 23, lift gear 27, and a gear motor 24. In this embodiment of the device, the gear motor is mounted on the to the vertical platform push rods 22 in a manner such that the teeth of the gear motor (not pictured) engage the teeth 30 of the lift gear 27. The gear motor is electrically powered and can rotate its gear clockwise and counter clockwise, and is equipped with an internal brake which will prevent unwanted movement of platform assembly 5 upwards or downwards. When the operator operates the gear motor in the counterclockwise direction the platform assembly 5 will move upwards, and when the operator operates the gear motor in the clockwise direction the platform assembly 5 will move in the downwards direction.

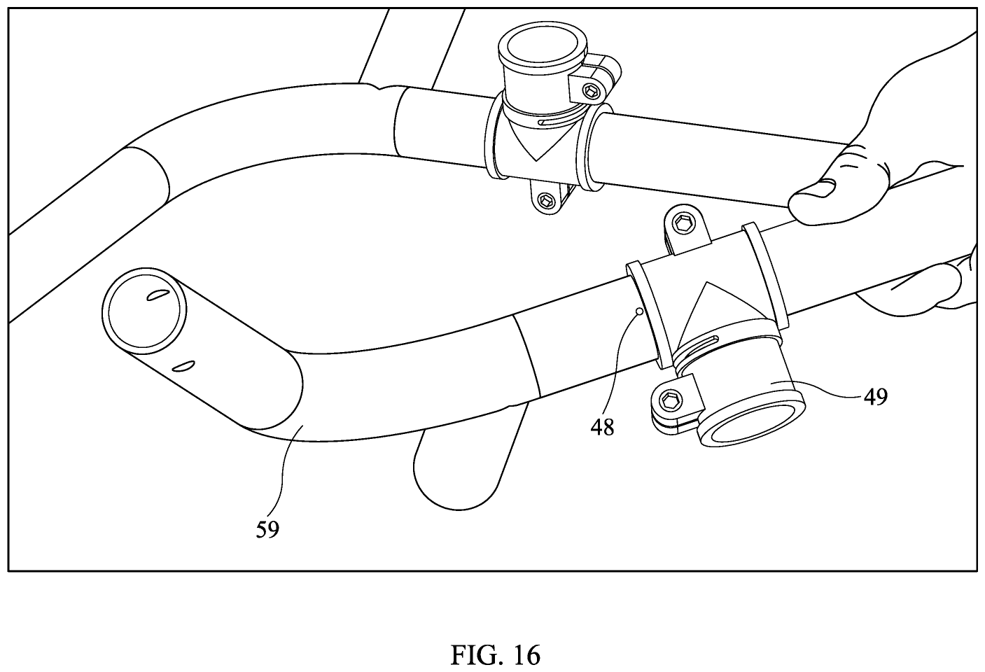

FIG. 16 provides a close up view of components used in each of the base unit 3, vertical support structure 4, platform assembly 5, hardtop interface platform 14, and all multicomponent units of the larger device, such components being alignment markers 48, designed as preformed dimples or indentations into the tubular components evidencing the location for alignment of other components, whether slide-over tube components or attachment sockets 49. In a preferred embodiment, such alignment markers are brightly colored to enhance visibility.

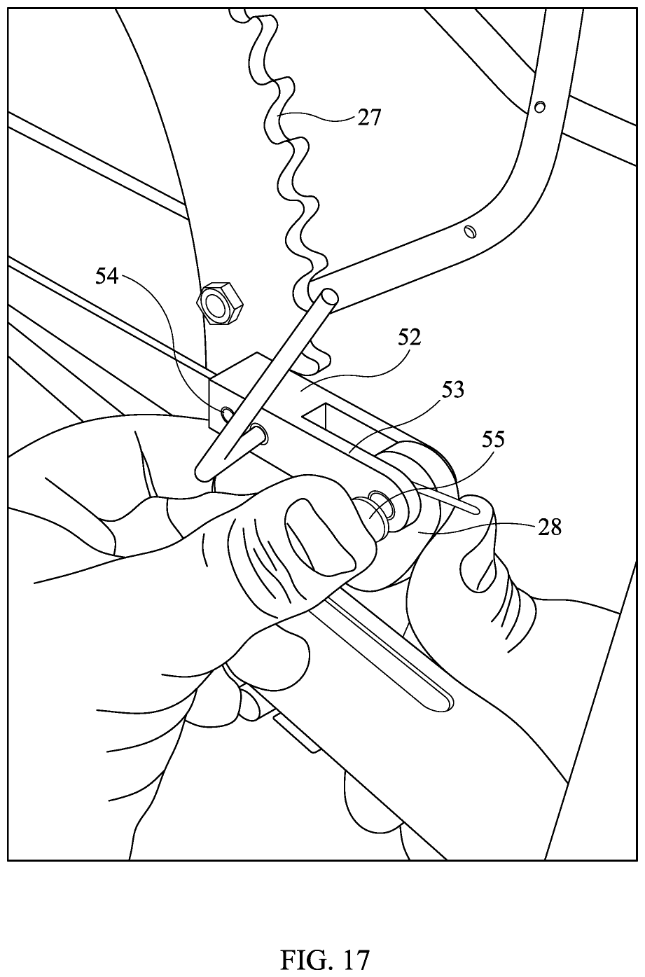

Referring to FIG. 17, yoke 52 is a rectangular, box-shaped component overlaying cable 33 (not pictured) and connecting it to an end of pawl 28 with yoke pawl engagement screw 55. Located at the end of the yoke that is opposite the end attached to the yoke are located two yoke tightening screws 54, running from one sidewall 53 of the yoke to the other such sidewall. Upon insertion of the cable between the sidewalls of the yoke, the tightening screws can be manually tightened to engage and grasp the cable. As utilized herein, the term “screw” may be used to refer to any type of metal or plastic connective device, including but not limited to snaps, pins and bolts.

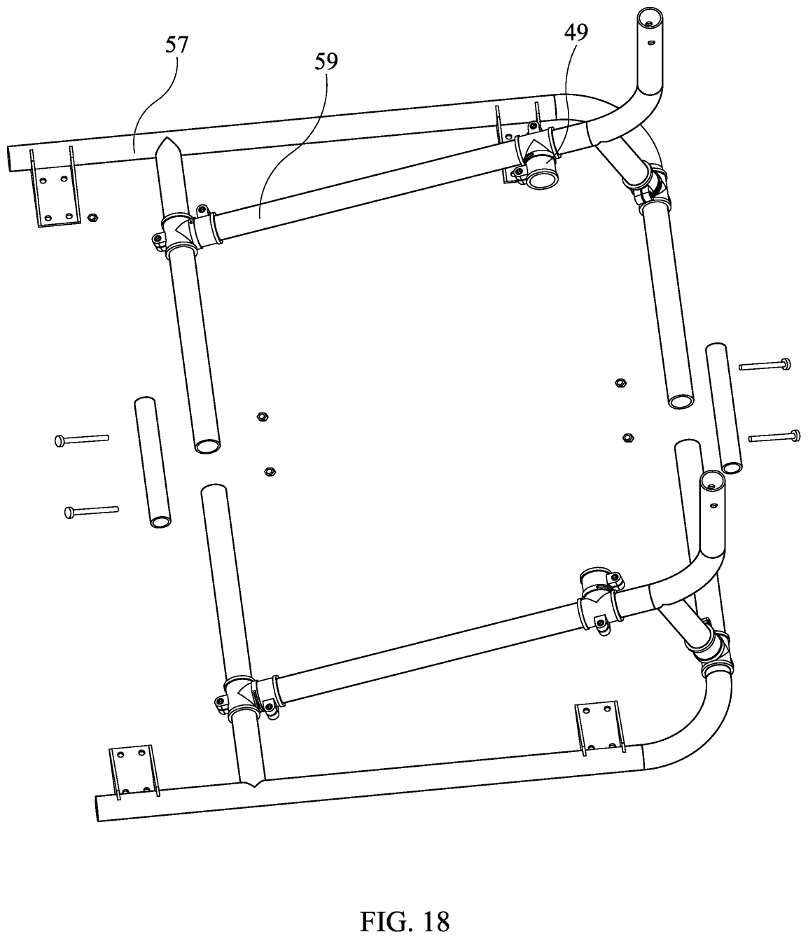

Referring to FIG. 18, a partially exploded view evidencing another preferred embodiment of the wheeled base unit 3, wherein such base unit is a multicomponent unit, providing comparative ease of shipping and also storage of the unit in its disassembled state. In such embodiment, components include two u-tubes 57, two connection bars 58 (not pictured) residing inside the u-tube tubing for stability and connection, with screws 51 extending through corresponding holes in each of the u-tubes and connection bars. At least two casters 7 (not pictured) are attached to the underside of each u-tube. A first end of a y-shaped support bar 59 is attached to a u-tube at an upward angle with a t-connector 49, with each of the two support bars being connected via a crossbar 60 (not pictured), also attached to a corresponding midpoint of each support bar with a t-connector. Such t-connectors are embodied as molded plastic components, again in a tubular design with two open holes in one direction and a single open hole in a perpendicular direction, such that a metal tube component such as a u-tube may be slid completely through the t-connector in one direction, while a second component may be connected to the first by sliding it terminally into the single-hole direction. Each support bar is a y-shaped tubular design with three ends for three different points of connection.

The second end of each support bar 59 opposite the connection to the u-tube is downward-facing and inserted into another t-connector 49, which connects to the same u-tube at a different location, while the third end of each support bar faces upward for attachment to the vertical support structure 4 (not pictured).

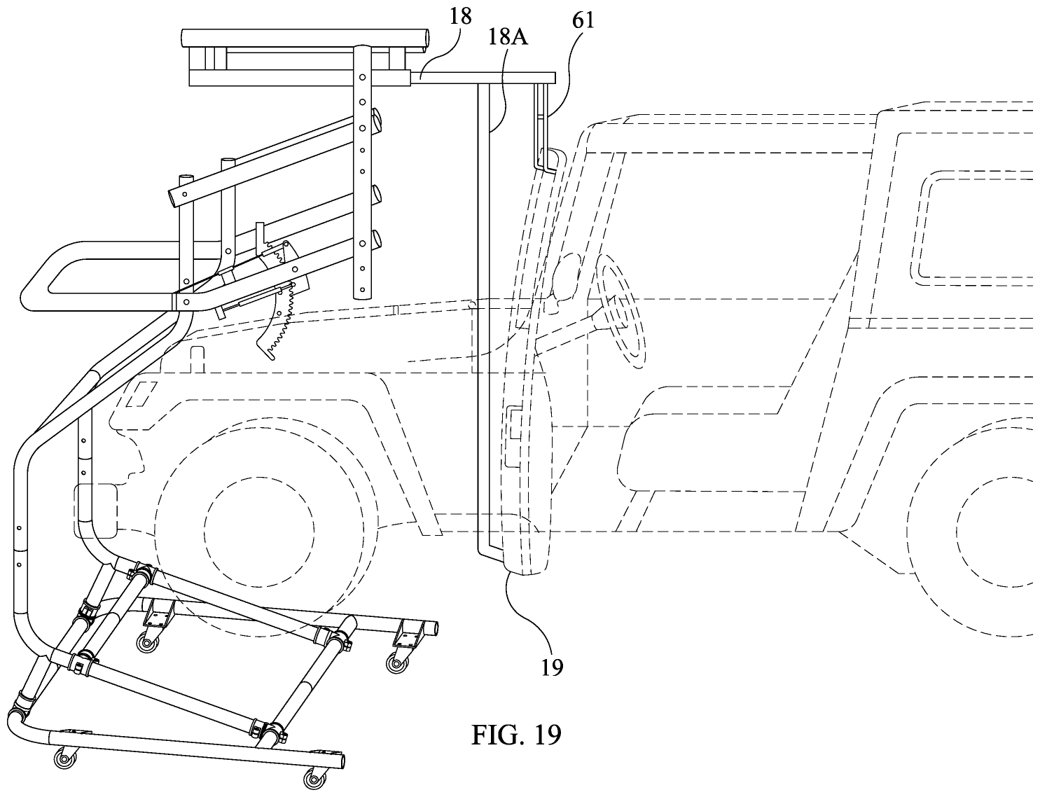

Referring to FIG. 19, the disclosed device can also be configured for simple removal and storage of detachable doors from those vehicle models offering such a feature, for example some Jeep Wranglers®. In FIG. 19, the SUV top platform 17 is again supplemented with removable support rails 18, although in this embodiment each such support rails further comprises a removable support rail extension 18A that is attached to the support rail at a midpoint via snap pin assembly 56 (not pictured) and extends groundward in a vertical position, ending in a front edge grip 19, also attached via snap pin assembly and extending perpendicularly from the support rail extension such that the front edge grip cradles the lower edge of the door. This embodiment further comprises two u-shaped top edge grips 61, each attached to the distal end of a support rail via snap pin, which top edge grips cradle the upper portion of the door through the window opening while the front edge grip 19 cradles the lower door. This configuration thus provides four independent points of support for the door, providing ample stability when moving the device away from the SUV 2.

While the description above describes a device designed for the removal of SUV convertible tops and SUV detachable doors, as there is currently a demand for this type of device, the described device with minor modifications known to those skilled in the art could also be used for removing different types of vehicle tops and doors, including but not limited to removable hardtops for cars, and caps for truck beds.

It would be appreciated by those skilled in the art that various changes and modifications can be made to the illustrated embodiments without departing from the spirit of the present invention. All such modifications and changes are intended to be covered by the appended claims.

### LIST OF REFERENCE NUMBERS

1 removable hardtop
1A removable door
2 convertible SUV
3 wheeled base unit
4 vertical support structure
5 platform assembly
α slope angle of platform assembly
6 legs
7 casters (wheels)
8 slide-over connections (not pictured)
9 U-shaped frame (bottom component)
10 tires (of SUV)
11 variable height support beams
12 aligning holes for pins (pins not pictured)
13 hinged/pivoting connections
14 hardtop interface platform
15 ratcheting lift assembly
16 tilting assembly
17 SUV top platform
18 removable support rails
18A removable support rail extension
19 front edge grip
20 groove or notch (in hardtop)
21 lift lever (aka U-shaped bar, middle component)
22 vertical platform push rods
23 horizontal lift support members
24 ratcheting mechanism
26 straight section of 21
27 lift gear
28 pawl
29 release mechanism
30 plurality of teeth
31 bracket
32 spring
33 cable
34 tensioning mechanism
35 pivot brackets
36 platform lock
37 release mechanism
38 rest rail
39 brackets
40 spring
41 hook
42 hole (in SUV top platform 17)
43 cable
44 tensioning mechanism
45 molded pad
46 rear gate (of SUV)
47 glass (of hardtop)
48 alignment marker
49 t-connector
50 socket head
51 screw
52 yoke
53 yoke sidewalls
54 yoke tightening screws
55 yoke pawl engagement screw
56 snap pin assembly
57 u-tube
58 connection bar
59 support bar
60 crossbar
61 top edge grip

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

I claim:

1. An apparatus for removing, storing, and installing removable hardtop devices from vehicles comprising:
a movable base unit which is sufficiently long and wide to support the apparatus from longitudinal and axial moments with and without the hardtop engaged;
a vertical support structure having a lower and upper end, wherein said lower end is affixed to said movable base and said upper end is attached to a means for vertical lifting:
a means for vertical lifting which is connected to said vertical support structure and allows the apparatus to exert force vertically for removing the hard top from the vehicle, sustaining the hardtop at a fixed height once the hardtop has been removed from the vehicle, and allowing the hardtop to be controllably lowered onto the vehicle during installation;
a top platform assembly attached to said vertical lifting means, which top platform assembly slopes upward away from the device at an angle of 1 degree to five degrees and interfaces with the hardtop to distribute lifting forces evenly throughout the hardtop and is capable of securing and supporting the hard top longitudinally and axially while the hardtop is installed on the apparatus; and
wherein the apparatus may be positioned to the hardtop while is installed on the automobile and selectively raised or lowered by said vertical lifting means.

2. The apparatus of claim 1, further comprising wherein molded pads are affixed to the upper surface of the top platform to cushion and protect the vehicle hard top upon engagement and removal by the device.

3. The apparatus of claim 1, further comprising wherein the device is comprised of slidably assembled tubular components, and alignment markers embodied as colored dimples are located on individual tubular components evidencing the location for alignment of other components upon assembly.

4. The apparatus of claim 1, wherein a plurality of casters from 3″ to 6″ in diameter are attached to the underside of the movable base.

5. The apparatus of claim 4, wherein the casters are each 4″ in diameter.

6. The apparatus of claim 1, wherein the top platform comprises detachable support rail and separately detachable support rail extenders to extend the horizontal area available for removal of larger hardtops.

7. The apparatus of claim 6, wherein the support rails and support rail extenders are each tubular designs with a squared exterior configuration.

8. The apparatus of claim 1, further comprising wherein the means for vertical lifting which is connected to the vertical support structure comprises a cable running through an adjustable yoke with two manually adjustable screws that can be tightened to secure said cable.

9. The apparatus of claim 1, wherein the angle of slope of the top platform assembly is approximately three degrees.

10. The apparatus of claim 6, configured for removal of vehicle doors, wherein
each detachable support rail extender extends vertically downward towards the movable base from a midpoint of the corresponding support rail;
each support rail terminates in a top edge grip for engaging the vehicle door along a top edge of a window opening;
each support rail extender terminates in a front edge grip for engaging the vehicle door along its lower edge.

11. A method of removing a removable hardtop from a vehicle using the apparatus of claim 1, such apparatus comprising a movable base structure, a vertical support structure, a means of vertical lifting and a top platform assembly, such method comprising the steps of:
positioning the movable base unit to the back of the vehicle;
positioning the vertical support structure having a lower end and upper end, wherein said lower end is affixed to said movable base and said upper end is attached to a means for vertical lifting;
engaging the top platform with the hardtop to effect lifting, wherein the top platform assembly is attached to the vertical lifting means and such top platform assembly slopes upward away from the apparatus at an angle of 1 degree to five degrees and interfaces with the hardtop to distribute lifting forces evenly throughout the hardtop and is capable of securing and supporting the hard top longitudinally and axially while the hardtop is installed on the apparatus; and
moving the means for vertical lifting, which is connected to said vertical support structure, thereby exerting vertical force to remove the hardtop from the vehicle, sustain the hardtop at a fixed height, and thereafter allow the hardtop to be controllably lowered onto the vehicle during reinstallation.

12. A method of removing a removable door from a vehicle using the apparatus of claim 10, such apparatus comprising a movable base structure, a vertical support structure, a means of vertical lifting and a top platform assembly, such method comprising the steps of:
positioning the movable base unit to the side of the vehicle with the door to be removed and facing the rear of the vehicle;
positioning the vertical support structure having a lower end and upper end, wherein said lower end is affixed to said movable base and said upper end is attached to a means for vertical lifting;
engaging the two rail extenders with the vehicle door to effect lifting, wherein the two top edge grips engage the vehicle door along a top edge of a window opening and the two front edge grips engage the vehicle door along its lower edge; and
moving the means for vertical lifting, which is connected to said vertical support structure, thereby exerting vertical force to remove the door from the vehicle, sustain the door at a fixed height, and thereafter allow the door to be controllably lowered onto the vehicle during reinstallation.
